(19) United States
(12) Patent Application Publication
(10) Pub. No.: US 2026/0193569 A1
(43) Pub. Date: Jul. 9, 2026

(54) PROCESS FOR CROSSLINKING POLYSACCHARIDES IN A CONCENTRATED AQUEOUS-ORGANIC MEDIUM – DETERGENT FORMULATIONS COMPRISING SAME

(71) Applicant: SOCIETE D'EXPLOITATION DE PRODUITS POUR LES INDUSTRIES CHIMIQUES SEPPIC, Paris (FR)

(72) Inventors: Miruna Bodoc, Paris (FR); Helene Candille, Paris (FR); Aurelie Colas, Paris (FR); Jerome Guilbot, Paris (FR); Stephane Monteillet, Paris (FR)

(73) Assignee: SOCIETE D'EXPLOITATION DE PRODUITS POUR LES INDUSTRIES CHIMIQUES SEPPIC, Paris (FR)

(21) Appl. No.: 19/441,563

(22) Filed: Jan. 6, 2026

(30) Foreign Application Priority Data
Jan. 7, 2025 (FR) 2500128

(51) Int. Cl. C11D 3/22; C08B 37/00; C08J 3/09; C08J 3/24

(52) U.S. Cl. CPC C11D 3/222; C08B 37/0033; C08J 3/09; C08J 3/24; C11D 2111/44

(57) ABSTRACT

A process for preparing a crosslinked polysaccharide includes preparing a water-polar solvent mixture; dispersing at least one polysaccharide in the water-polar solvent mixture to obtain a reaction medium; adjusting a pH of the reaction medium; crosslinking the at least one polysaccharide by adding, to the basic reaction medium, a phosphate crosslinking agent selected from the group consisting of sodium trimetaphosphate (STMP), sodium tripolyphosphate (STPP), and combinations thereof to obtain a basic dispersion comprising at least one crosslinked polysaccharide; adjusting a pH of the basic dispersion to a value less than or equal to 7.0 to obtain a non-basic dispersion of the at least one crosslinked polysaccharide; and filtering the non-basic dispersion obtained at the end of step e) to recover therefrom the at least one crosslinked polysaccharide.

### TECHNICAL FIELD OF THE INVENTION

The invention relates to domestic and industrial detergency. The invention relates more particularly to a novel process for the synthesis of thickeners of natural origin used in such formulations.

### PRIOR ART

The detergent formulations for industrial or domestic use of the prior art are either alkaline or acidic.
Alkaline detergent formulations are generally used to remove greasy soiling from solid surfaces.
Acidic detergent formulations are used not only to remove greasy soiling but also for descaling said surfaces, notably those of equipment of the agri-food industry, or of household electrical appliances, such as dishwashers and coffee machines. In addition, they are also used for removing concrete or cement residues, and for cleaning concrete surfaces that are ingrained with grease, before carrying out any painting. They should not cause substantial formation of foam during the cleaning operation and they must have good foaming and detergent properties.

Detergent formulations for industrial or domestic use are in the form of powders, concentrates, liquids such as emulsions, and, depending on the case, are used directly or after dilution in a suitable solvent. In liquid form, such as emulsions in particular, they include rheology modifiers for polar phases. Polymers that modify the rheology of polar phases include in particular anionic or cationic, amphiphilic, linear or branched, crosslinked or non-crosslinked polyelectrolytes. These polymers, once introduced into polar phases, have the property of being deployed, in the polar phase, under the effect of electrostatic repulsive forces due to the presence of the negative and/or positive charges on the linear or branched, crosslinked or non-crosslinked, polymer backbone. Rheology modifiers simultaneously provide an increase in the viscosity of the polar phase, and impart a certain consistency and stability to the detergent or cleaning composition to be thickened.

Despite the large commercial offering, the demand for new thickeners for polar phases, for detergent formulations for industrial or domestic use, remains current because the polymers used today are predominantly of petrochemical origin, while the user industries are engaged in an ecodesign process. It is therefore necessary to develop alternative thickeners which, while having comparable properties, have an improved environmental profile, either due to their origin or that of their precursors, or due to their biodegradable nature. The use of polysaccharides seems to be an acceptable alternative solution because they have already been used industrially for many years as texture or rheology modifiers for preparing pharmaceutical, cosmetic or food products.

Depending on their chemical composition, they can be used as gelling agents or as thickeners. A “thickener” is understood to mean a chemical compound which increases the viscosity of the medium into which it is introduced. A “gelling agent” is understood to mean a compound which transforms a liquid medium into a structured state, which does not flow, by formation of a three-dimensional network within the liquid; the gel being considered as an intermediate state between the liquid state and the solid state.

Polysaccharides are polymers of saccharides, or more commonly of sugars. According to the International Union of Pure and Applied Chemistry (IUPAC), the term saccharides denotes monosaccharides, compounds of monosaccharides themselves and derivatives thereof, obtained either by reduction of a carbonyl group, or by oxidation of one or more hydroxyl functions, or by replacing one or more hydroxyl functions with a hydrogen atom, or an amine, phosphate or sulfate function.

The polysaccharides most commonly used for the abovementioned industries are predominantly chosen from polymers containing monomer units of monosaccharides such as glucose, galactose, mannose, xylose and arabinose or monomer units of derivatives of monosaccharides in which the hydroxyl function of the terminal carbon has been oxidized to a carboxyl function.

Polysaccharides consisting solely of monosaccharides (poly-monosaccharides) include in particular:
starch, and derivatives of starch, which is a glucose homopolymer with alpha-1,4 glycosidic linkages: a distinction is made between the linear homopolymer (alpha-1,4 linkages only) known as amylose (about 20% of the starch) and a branched homopolymer (alpha-1,4 and alpha-1,6 glycosidic linkages) known as amylopectin (about 80% of the starch). Starch is obtained from plants such as wheat, corn or potatoes;
cellulose, which is a glucose homopolymer with beta-1,4 glycosidic linkages: cellulose is extracted from wood and is mainly used in the paper industry to produce pulp;
hemicellulose, which is a polymer of various sugars such as glucose, mannose, galactose, xylose, arabinose and rhamnose, xylose often being the main one, and hemicellulose also sometimes containing uronic acids.

The polysaccharides consisting of derivatives of monosaccharides include:
sulfated galactans, which are polymers of galactose which may have pendant sulfate-ester groups, such as algal polysaccharides or agar;
uronans, which are polymers of uronic acids such as algins and pectins;
heteropolymers of monosaccharides, including galactomannans, such as guar gum, tara gum, locust bean gum and fenugreek gum, and glucomannoglycans, such as konjac gum; and
xyloglycans such as tamarind gum;
heteropolymers of monosaccharides and uronic acids; these polymers are found in particular in sap exudates, such as the exudates of gum arabic and karaya gum; they are also produced by microorganisms such as xanthan gum and gellan gum;
glucosaminoglycans: these are polysaccharides formed from glucose by replacing its C-2 hydroxyl with an amine function (referred to as 2-amino-2-deoxy-D-glucose or glucosamine); the amine function may be acetylated. The polysaccharides in this class include chitosan, formed solely of glucosamine units, chitin with acetylated amine functions and hyaluronan, the repeat unit of which is a dimer of glucosamine and of glucuronic acid.

Chemical modification of polysaccharides is one way to increase their initial performance and also to provide new properties. This is either chemical functionalization by grafting of new chemical groups of relatively high molecular weights, or crosslinking, which consists in combining the polysaccharide chains with one another by means of an at least difunctional crosslinking agent known as a crosslinker. In both cases, the functions of the starting polysaccharides involved remain hydroxyl groups (monosaccharides), amino groups (glucosamine derivatives) or carboxylic groups (uronic acid derivatives).

However, such functionalizations are often carried out with reactants that are environmentally unfriendly or according to procedures that only partially comply with the twelve principles of green chemistry, such as the use of organic solvents. In addition, the corresponding products obtained do not currently make it possible to compete, in terms of thickening or gelling performance, with the thickening polymers of petrochemical origin on the market.

Among the crosslinking agents commonly used for crosslinking natural polysaccharides, only those belonging to the family of polyphosphate derivatives such as sodium trimetaphosphate (STMP) or sodium tripolyphosphate (STPP) are advantageous from an environmental point of view. STMP is a compound that is non-toxic to humans and is commonly used in the food and pharmaceutical industries; it is synthesized by high-temperature dehydration of sodium polyphosphate; it is partially soluble in cold water, very sparingly soluble in hot water, and insoluble in methanol, diethyl ether, n-octanol and acetone. The crosslinking of polysaccharides with (STMP), described in the patent or academic literature, is carried out in an aqueous medium, under basic pH conditions, at a temperature between 20° C. and 50° C. for several hours.

However, the crosslinking processes used to date result in crosslinked natural polymer gels that are highly diluted, i.e. approximately containing 3% by weight of crosslinked polymer. Such a dilution does not make it possible to prepare crosslinked natural polysaccharides in powder form on an industrial scale. Moreover, the commercialization of such a hydrogel, namely a solution comprising water and crosslinked polysaccharide at a weight content of 3% or 5% generates prohibitive logistical additional costs due to the large quantity of water to be transported. There is therefore a need to develop a crosslinking process that leads to a gel of a polymer of natural origin that is either more concentrated or devoid of added water, and that is in the form of a powder.

### DESCRIPTION OF THE INVENTION

This is the reason why, according to a first aspect, one subject of the invention is a process for preparing at least one crosslinked polysaccharide, comprising the following steps:
a step a) of preparing a water-polar solvent mixture, said polar solvent being chosen from the group consisting of aliphatic alcohols containing from one to four carbon atoms, ketones containing from three to five carbon atoms and polyols containing two or three hydroxyl groups and from two to six carbon atoms, said preparation being carried out by mixing water and said polar solvent in weight proportions such that the weight ratio of polar solvent to water is greater than or equal to 0.4 and less than or equal to 19.0;
a step b) of dispersing at least one polysaccharide in said water-polar solvent mixture prepared in step a), in order to obtain a reaction medium comprising, per 100% of its weight, a weight proportion of polysaccharide of greater than 10% by weight and less than or equal to 55% by weight, said polysaccharide being chosen from the group consisting of xanthan gum, xanthan grafted with hydrocarbon chains containing from two to twenty-two carbon atoms and more particularly xanthan gum esterified with dodecanoic acid, guar and konjac gums, carrageenans and more particularly kappa-carrageenan and iota-carrageenan and mixtures of two or more of said polysaccharides from this group;
a step c) of adjusting the pH of the reaction medium prepared in step b) to a value greater than or equal to 8.0 and less than or equal to 13.0 and more particularly greater than or equal to 8.5 and less than or equal to 12.5 by adding a base thereto;
a step d) of crosslinking said at least one polysaccharide by adding, to the basic reaction medium obtained at the end of step c), a phosphate crosslinking agent chosen from the group consisting of sodium trimetaphosphate (STMP) and sodium tripolyphosphate (STPP), in order to obtain a basic dispersion comprising crosslinked polysaccharide;
a step e) of adjusting the pH of said basic dispersion obtained at the end of step d), to a value less than or equal to 7.0 in order to obtain a non-basic dispersion of said crosslinked polysaccharide;
a step f) of filtering said non-basic dispersion obtained at the end of step e) in order to recover therefrom said at least one expected crosslinked polysaccharide, optionally followed by:
either a drying step g) in order to remove traces of residual solvents therefrom,
or a step h) of atomizing said at least one crosslinked polysaccharide obtained in step f) in order to obtain a powder therefrom.

According to a particular aspect of the process as defined above, steps a) and b) are simultaneous and constitute a single step A) of preparing a reaction medium by mixing water, a polar solvent chosen from the group consisting of aliphatic alcohols containing from one to four carbon atoms, ketones containing from three to five carbon atoms and polyols containing two or three hydroxyl groups and from two to six carbon atoms, and a polysaccharide in proportions such that:
the weight proportion of said at least one polysaccharide is greater than 10% by weight and less than or equal to 55% by weight of said reaction medium and that
the weight ratio of polar solvent to water in said mixture is greater than or equal to 0.4 and less than or equal to 19.0.

In the process as defined above, the polar solvent of the mixture prepared in step a) or of said reaction medium prepared in step A) is more particularly chosen from the group consisting of methanol, ethanol, butanol, isopropanol, acetone, methyl ethyl ketone, glycerol, 1,3-propanediol, butylene glycol, 1,3-butanediol, pentylene glycol, hexylene glycol and 2-methyl-2,4-pentanediol; according to this particular embodiment, said polar solvent is very particularly chosen from the group consisting of ethanol and isopropanol.

In the process as defined above, one or more salts are optionally added during the preparation of the water-solvent mixture prepared in step a) or of said reaction medium prepared in step A), for example a salt chosen from the group consisting of sodium chloride, calcium chloride, magnesium chloride, calcium sulfate, magnesium sulfate, calcium carbonate, magnesium carbonate, magnesium aspartate and other monovalent or divalent salts that are acceptable in the cosmetics, pharmaceutical, plant protection and food industries.

In the process as defined above, the weight ratio of polar solvent to water in said mixture prepared in step a) or in said reaction medium prepared in step A) is more particularly greater than or equal to 1.0 and less than or equal to 4.0.

In the process as defined above, the reaction medium prepared in step b) or in step A) comprises more particularly, per 100% of its weight, a weight proportion of said at least one polysaccharide of greater than or equal to 15% and less than or equal to 45% by weight.

According to a particular aspect of the present invention, if necessary, step b) of solubilizing or dispersing said at least one polysaccharide or step A) of preparing said reaction medium is carried out at a temperature of between 50° C. and 100° C., preferably between 60° C. and 80° C.

In the process as defined above, step c) is carried out by adding to the reaction mixture prepared in step b) or step A), an alkaline base, such as sodium hydroxide or potassium hydroxide, ammonium hydroxide, or an amine base. Use is more particularly made of sodium hydroxide, and in particular an aqueous tetramolar sodium hydroxide solution, potassium hydroxide, ammonium hydroxide or triethylamine. In the process as defined above, in step c), the pH is more particularly adjusted to a value greater than or equal to 10.0 and less than or equal to 12.5.

In the process as defined above, the weight ratio of STMP or STPP crosslinker used in step d) to said at least one starting polysaccharide is greater than or equal to 0.0001 and less than or equal to 0.0700; it is more particularly greater than or equal to 0.0003 and less than or equal to 0.0300. The crosslinking temperature may vary between 5° C. and 100° C., preferably between 10° C. and 80° C. and ideally between 20° C. and 70° C.

According to another particular embodiment of the process as defined above, the crosslinking agent used in step d) is sodium trimetaphosphate (STMP).

In the process as defined above, step e) of adjusting the pH is carried out in particular with a strong acid such as hydrochloric acid or sulfuric acid, to stop the crosslinking mechanism. It is generally carried out at ambient temperature, between 15° C. and 35° C.

The process as defined above makes it possible to obtain polysaccharide gels which are more concentrated, or even in solid form, which makes it possible industrially to use them as a replacement for polymers of petroleum origin.

This is why another subject of the invention is the use of a crosslinked polysaccharide or of a mixture of crosslinked polysaccharides as obtained by the process as defined above for thickening, stabilizing or emulsifying a detergent formulation for industrial or domestic use comprising a polar phase. A further subject of the invention is the use of the crosslinked polysaccharide as obtained by the process as defined above for suspending solid particles in a detergent formulation for industrial or domestic use comprising a polar phase.

This is why another subject of the invention is an aqueous formulation for industrial or domestic use comprising a polar phase, characterized in that it comprises, per 100% of its weight, from 0.10% to 10.0% and more particularly from 0.5% to 5.0% of a crosslinked polysaccharide or a mixture of crosslinked polysaccharides obtained by the process as defined above, as thickener, as stabilizer or as emulsifier for said detergent formulation for industrial or domestic use comprising a polar phase or as an agent capable of and intended for suspending solid particles within said aqueous detergent formulation for industrial or domestic use comprising a polar phase.

For the purposes of the present invention, a detergent formulation for industrial or domestic use, comprising a polar phase is understood to mean compositions that are liquid at 20° C., designed and used for cleaning various types of surfaces, for example textile fibres, glass, ceramics, tiles, wood, metal, composite materials. They find their applications for cleaning soiling from said surfaces, such as cleaning bottles or dishes manually or in a machine, cleaning laundry manually or in a machine, cleaning floors, metal surfaces soiled with grease, windows, toilets or storage tanks.

In the context of the present invention, the polar phase constituting the detergent formulation for industrial or domestic use, comprising a polar phase, is chosen in particular from the group consisting of water, aqueous-alcoholic mixtures, such as water-ethanol, water-propanol, water-isopropanol, water-butanol, water-isobutanol, water-sec-butanol and water-tert-butanol, water-polyol mixtures such as water-ethylene glycol, water-propylene glycol, water-butylene glycol, water-glycerol or water-1,3-propanediol.

Among these detergent formulations for industrial or domestic use, comprising a polar phase, a distinction can be made between alkaline detergent formulations and acidic detergent formulations. They are generally in the form of a solution, an aqueous solution, an emulsion or a microemulsion with an aqueous continuous phase, an emulsion or a microemulsion with an oily continuous phase, an aqueous gel, a foam, or else in the form of an aerosol. It may be applied directly by soaking, by spraying or by vaporizing onto the surface to be cleaned or else by means of any type of support intended to be placed in contact with the solid surface to be cleaned (paper, wipe, textile).

In the context of the present invention, a stabilizer for said detergent formulation for industrial or domestic use, comprising a polar phase, means that said crosslinked polysaccharide or said mixture of crosslinked polysaccharides as obtained by the process as defined above, is capable of and intended for stabilizing said formulations which are in the form of emulsions or microemulsions, by giving them a homogeneous appearance during storage under various conditions, and more particularly at 25° C. for a period at least equal to one month, and more particularly at 4° C. for a period at least equal to one month, and more particularly at 45° C. for a period at least equal to one month.

In the context of the present invention, an agent capable of and intended for suspending solid particles within said aqueous detergent formulation for industrial or domestic use, comprising a polar phase, means that said crosslinked polysaccharide or said mixture of crosslinked polysaccharides as obtained by the process as defined above, is capable of and intended for suspending solid particles having an average apparent diameter of between one micrometre and five millimetres, more particularly between ten micrometres and one millimetre, which may have various, regular or irregular geometries, and in particular be in the form of pearls, beads, rods, flakes, lamellae or polyhedra. Examples of such solid particles include micas, iron oxides, titanium oxides, zinc oxide or aluminium oxides, talc, silica, kaolin, clays, boron nitride, calcium carbonate or magnesium carbonate, magnesium hydrogen carbonate, inorganic coloured pigments, polyamides, such as nylon-6, polyethylenes, polypropylenes, polystyrenes, polyesters, acrylic or methacrylic polymers, such as polymethyl methacrylates, polytetrafluoroethylene, crystalline or microcrystalline waxes, porous spheres, selenium sulfide, zinc pyrithione, starches, alginates, plant fibres, loofah particles and sponge particles.

In general, said detergent formulation for industrial or domestic use, comprising a polar phase, that is the subject of the present invention also comprises ingredients usually used in the field of cleaning solid surfaces or textile fibres, such as nonionic, cationic or amphoteric surfactants, cationic or nonionic polymers, defoaming surfactants or low-foaming surfactants, thickeners, enzymes, bleaching agents, anticorrosion agents, solvents, acidic agents, alkaline agents, anti-scaling agents, preservatives, fragrances, colorants, repellents, oxidizing agents, detergency adjuvants, anti-soiling agents or anti-redeposition agents.

The term “detergent surfactants” denotes surface active agents which give said detergent formulation for industrial or domestic use, comprising a polar phase, as defined above, the ability to detach soiling present on the solid surfaces to be cleaned, and to keep the soiling in suspension, in order to then be removed during the rinsing step. These detergent surfactants may be of anionic, cationic, amphoteric or nonionic nature.
Examples of anionic detergent surfactants optionally present in the detergent formulation as defined above include alkali metal salts, alkaline-earth metal salts, ammonium salts, amine salts or amino alcohol salts of alkyl ether sulfates, of alkyl sulfates, of alkylamido ether sulfates, of alkylaryl polyether sulfates, of monoglyceride sulfates, of alpha-olefin sulfonates, of paraffin sulfonates, of alkyl phosphates, of alkyl ether phosphates, of alkyl sulfonates, of alkylamide sulfonates, of alkylaryl sulfonates, of alkyl carboxylates, of alkyl sulfosuccinates, of alkyl ether sulfosuccinates, of alkylamide sulfosuccinates, of alkyl sulfoacetates, of alkyl sarcosinates, of acyl isethionates, of N-acyl taurates, of acyl lactylates, of N-acyl derivatives of amino acids, of N-acyl derivatives of peptides, of N-acyl derivatives of proteins, and of fatty acids.
Examples of amphoteric detergent surfactants optionally present in the detergent formulation as defined above include alkyl betaines, alkyl amido betaines, sultaines, alkyl amidoalkyl sulfobetaines, imidazoline derivatives, phosphobetaines, amphopolyacetates, amphopropionates, β-alanine, and sodium N-(2-carboxyethyl)-N-(2-ethylhexyl) sold under the brand name Tomamine® 30 Amphoteric 400 Surfactant.
Examples of cationic detergent surfactants optionally present in the detergent formulations as defined above include quaternary ammonium derivatives.
Examples of nonionic detergent surfactants optionally present in the detergent formulation as defined above include alkyl polyglycosides containing a linear or branched, saturated or unsaturated aliphatic radical comprising from 8 to 16 carbon atoms; castor oil derivatives, polysorbates, coconut amides and N-alkylamines.

Examples of acidic agents optionally present in the detergent formulation as defined above include:
mineral acids such as hydrochloric, nitric, phosphoric, sulfuric, sulfamic, hypophosphorous, phosphorous, hypochlorous, perchloric, boric, manganic, permanganic, chromic, periodic, iodic, hypoiodous, hydrobromic, hydroiodic and hydrofluoric acids;
organic acids such as formic, carbonic, acetic, propionic, benzoic, salicylic, oxalic, succinic, glutamic, adipic, glycolic, lactic, malic, maleic, tartaric, citric, sorbic, dihydroacetic, dimethylsulfamic, fumaric, glutamic, isopropylsulfamic, valeric, benzenesulfonic, xylenesulfonic, 2-ethylhexanoic, capric, caproic, cresylic, dodecylbenzenesulfonic, peracetic, chloroacetic and gluconic acids.

Examples of alkaline agents optionally present in the detergent formulation as defined above include alkali or alkaline-earth metal hydroxides such as sodium, potassium, barium or calcium hydroxides.

Examples of anti-scaling agents optionally present in the detergent formulation as defined above include elements of the group consisting of:
sequestrants that have the effect of complexing calcium and magnesium ions to form water-soluble complexes that are then removed during rinsing, such as sodium tripolyphosphate (STPP), ethylenediaminetetraacetate (EDTA), tetraacetylethylenediamine (TAED), methyl glycine diacetate (MGDA), sodium nitrolotriacetate (Na3NTA), sodium or potassium gluconates, sodium or potassium erythorbates, sodium or potassium polycarboxylates, and sodium citrate;
ion exchange agents which have the effect of exchanging their sodium ions and of complexing calcium and magnesium ions to form water-soluble complexes which are then removed during rinsing, such as sodium zeolites or aluminosilicates, or lamellar sodium silicates; and
precipitants which have the effect of removing ions responsible for solidity from the water by forming insoluble calcium compounds, which are subsequently removed with the soiling, such as calcium carbonate and sodium metasilicate.

According to a more particular aspect, the detergent formulation as defined above comprises at least one anti-scaling agent chosen from the elements of the group consisting of sodium metasilicate, sodium tripolyphosphate (STPP), ethylenediaminetetraacetate (EDTA), tetraacetylethylenediamine (TAED), methylglycine diacetate (MGDA), sodium nitrilotriacetate (Na3NTA), sodium gluconate, sodium citrate and calcium carbonate.

Examples of nonionic defoaming or low-foaming surfactants optionally present in the detergent formulation as defined above include:
block copolymers of ethylene oxide and of propylene oxide, and most particularly the block copolymers of ethylene oxide and of propylene oxide sold under the brand name Pluronic™, Pluronic™ PE 6100 and Pluronic™ PE 6200,
nonionic defoaming surfactants of formula: R1-X—((CH₂—CH(CH₃)—O)ᵤ—(CH₂—CH₂—O)ᵥ—Y)_{w} in which R1 represents a saturated or unsaturated, linear or branched hydrocarbon-based aliphatic radical comprising from 6 to 18 carbon atoms, X represents a nitrogen atom or an oxygen atom, u and v, which may be identical or different, each represent an integer of between 1 and 50, w is either equal to 1 if X represents an oxygen atom, or equal to 1 or to 2 if X represents a nitrogen atom, and Y represents a blocking functional group chosen from the elements of the group consisting of linear alkyl radicals comprising from 4 to 8 carbon atoms, for instance the butyl radical, the benzyl radical or a butylene oxide group; for example TERGITOL™ L61E and TERGITOL™ L64E;
nonionic low-foaming surfactants of formula R8-O—(S′)_{q}—H in which S′ represents the residue of a reducing sugar chosen from the elements of the group consisting of glucose, xylose and arabinose, R8 represents a saturated, linear or branched hydrocarbon radical, having 6 to 10 carbon atoms and q′ represents a decimal number greater than or equal to 1.05 and less than or equal to 5; for example hexylpolyglucosides, 2-ethylhexyl polyglucosides, n-heptyl polyglucosides or n-octyl polyglucosides; alkoxylated monoglycerides, alkoxylated diglycerides, alkoxylated terpene hydrocarbons such as ethoxylated and/or propoxylated alpha-pinenes or beta-pinenes, containing from 1 to 30 oxyethylene and/or oxypropylene units, products resulting from the condensation of ethylene oxide or propylene oxide with ethylenediamine, such as TETRONIC™ products sold by BASF, ethoxylated and/or propoxylated C8-C18 fatty acids containing from 5 to 25 mol of ethylene oxide and/or propylene oxide, ethoxylated fatty amides containing from 5 to 30 mol of ethylene oxide, ethoxylated amines containing from 5 to 30 mol of ethylene oxide, alkoxylated amidoamines containing from 1 to 50, preferably from 1 to 25, most particularly from 2 to 20 mol of ethylene oxide and/or propylene oxide.

Examples of thickeners or gelling agents optionally present in the detergent formulation as defined above include:
polysaccharides consisting solely of monosaccharides, such as glucans or glucose homopolymers, glucomannoglucans, xyloglycans, galactomannans of which the degree of substitution (DS) of the D-galactose units on the main D-mannose chain is between 0 and 1, and more particularly between 1 and 0.25, such as galactomannans originating from cassia gum (DS=0.20), locust bean gum (DS=0.25), tara gum (DS=0.33), guar gum (DS=0.50) or fenugreek gum (DS=1);
polysaccharides consisting of monosaccharide derivatives, such as sulfated galactans and more particularly carrageenans and agar, uronans and more particularly algins, alginates and pectins, heteropolymers of monosaccharides and of uronic acids, and more particularly xanthan gum, gellan gum, acacia gum exudates and karaya gum exudates, and glucosaminoglycans;
cellulose derivatives such as methyl cellulose, ethyl cellulose, hydroxypropyl cellulose, silicates, starch, hydrophilic starch derivatives, and polyurethanes.
inorganic thickeners such as, for example, clays, hectorite, saponite, sauconite, vermiculite or colloidal silica.

Examples of abrasive agents optionally present in the detergent formulation as defined above include materials of natural origin, for instance wood or kernel chips, inorganic abrasive materials such as oxides, quartzes, diatomaceous earths, colloidal silica dioxides, organic abrasive materials such as polyolefins, for instance polyethylenes and polypropylenes, polystyrenes, acetonitrile-butadiene-styrene resins, melamines, phenolic resins, epoxy resins or polyurethane resins.

Examples of other solvents optionally present in the detergent formulation as defined above include benzyl alcohol, chlorinated solvents, acetone, methyl ethyl ether, methyl isobutyl ether, butyl acetate, ethyl acetate, isopropyl acetate or isobutyl acetate; aromatic solvents, isoparaffins, isododecane, ethyl lactate or butyl lactate, terpenic solvents, rapeseed methyl esters, sunflower methyl esters, propylene glycol n-methyl ether, dipropylene glycol n-methyl ether, tripropylene glycol n-methyl ether, propylene glycol n-butyl ether, dipropylene glycol n-butyl ether, tripropylene glycol n-butyl ether, propylene glycol n-propyl ether, dipropylene glycol n-propyl ether, propylene glycol monomethyl ether acetate, propylene glycol diacetate, propylene glycol phenyl ether, ethylene glycol phenyl ether or dipropylene glycol dimethyl ether.

Examples of enzymes optionally present in the detergent formulation as defined above include proteases, amylases, lipases, cellulases and peroxidases.

Detergent formulations for industrial or domestic use, comprising a polar phase, are generally prepared by a process comprising the following successive steps:
a step a) of preparing an aqueous medium comprising water, optionally an alcohol or a polyol, in a jacketed tank in which jacket a heat-transfer fluid circulates at a regulated temperature,
a step b) of gradually adding said at least one crosslinked polysaccharide obtained by the process which is the subject of the present invention to the aqueous medium prepared in step a) at a moderate temperature of between 20° C. and 60° C., with moderate non-shearing stirring,
a step c) during which at least one detergent surfactant is added to the medium resulting from step b), and optionally
a step d) during which one or more additional ingredients are added to the medium resulting from step c).

According to another aspect, a subject of the invention is the use of said detergent formulation for industrial or domestic use, comprising a polar phase, as defined above, for cleaning surfaces.

According to another aspect, a subject of the invention is a process for cleaning a surface, characterized in that it comprises at least one first step a1) of applying said detergent formulation for industrial or domestic use, comprising a polar phase, followed by at least one step b1) of rinsing said surface.

In the context of the present invention the term “surface” denotes in particular floors, walls, window panes, tiles, household electrical appliances, kitchenware, countertops, tapware, sinks, tanks for storing chemical, food or agricultural products, vehicles, or textile surfaces. The materials constituting these solid surfaces are, for example, glass (soda-lime, fluorocalcium, borosilicate, crystal), porcelain, earthenware, ceramic, polycarbonate or polypropylene plastics, stainless steel, silver, copper, aluminium, wood, synthetic resins, glass-ceramic or linoleum, and may be coated with paints or varnishes.

In step a1) of the process as defined above, said detergent formulation is applied to the surface comprising the soiling to be cleaned by any means, for instance by total immersion, by spraying or by application by means of a support consisting of synthetic or natural, woven or nonwoven textile fibres, or paper, impregnated beforehand with said composition.

In step b1) of the process as defined above, the rinsing of the surface onto which said detergent formulation was applied during step a1) is performed by total immersion or by spraying with water.

Step b1) can be performed at room temperature or at a temperature of between 30° C. and 80° C., more particularly at a temperature of between 30° C. and 65° C.

### Examples

The following examples illustrate the invention without, however, limiting it.

Preparation of STMP-crosslinked xanthan in a water-ethanol mixture (according to the invention). The synthesis process comprises the following steps:
step A): charging a jacketed one-litre glass reactor with 193 g of an aqueous-alcoholic mixture of 95% ethanol and water in a weight ratio of 62/38 and 30 g of xanthan, with mechanical stirring,
step c): adjusting, at 25° C., the pH of the mixture prepared in step A) to a pH value equal to 12.5 using an aqueous tetramolar sodium hydroxide solution,
step d): adding, to the mixture obtained from step c) and heated to a temperature of 50° C., 0.018 g of STMP (i.e. 0.06% by weight relative to the xanthan); maintaining the stirring at this temperature for two hours, and then cooling to 25° C.,
step e): adjusting the pH of the reaction medium to 7 using an aqueous pentamolar hydrochloric acid solution,
step f): gravity filtration of the reaction medium on filter paper (average filtration of from 4 μm to 7 μm),
step g): drying the product recovered in step f) for between 16 and 20 hours in an oven thermostatically controlled at 50° C. under vacuum; 24 g of polysaccharide (P1) are thus obtained in the form of a white powder with a yield equal to 80% (relative to the xanthan introduced).

Preparation of STMP-crosslinked xanthan in a water-ethanol mixture (comparative). The same process as the one described in the paragraph describing the preparation of STMP-crosslinked xanthan in a water-ethanol (P1) was carried out, but adjusting the pH of step c) to 7.0 instead of 12.5. 24 g of polysaccharide (P1′) were isolated in the form of a white powder with a yield equal to 80% (relative to the xanthan introduced).

Preparation of STMP-crosslinked xanthan gum in a water-ethanol mixture (according to the invention). The synthesis process comprises the following steps:
step A): charging a jacketed one-litre glass reactor with 200 g of an aqueous-alcoholic mixture of 95% ethanol and water in a weight ratio of 75/25 and 60 g of xanthan gum, with mechanical stirring,
step c): adjusting, at 20° C., the pH of the mixture prepared in step A) to a pH value equal to 12.0 using an aqueous tetramolar sodium hydroxide solution,
step d): adding, to the mixture obtained from step c) and heated to a temperature of 35° C., 0.69 g of STMP (i.e. 1.15% by weight relative to the xanthan); maintaining the stirring at this temperature for one hour, and then cooling to 20° C.,
step e): adjusting the pH of the reaction medium to 7 using an aqueous pentamolar hydrochloric acid solution,
step f): gravity filtration of the reaction medium on filter paper (average filtration of from 4 to 7 μm),
step g): drying the product recovered in step f) for between 16 and 20 h in an oven at 50° C. under vacuum; the polysaccharide (P2) is thus obtained in the form of a white powder.

Preparation of STMP-crosslinked lipophilized xanthan in a water-ethanol mixture (according to the invention). The same process as the one described in the paragraph describing the preparation of STMP-crosslinked xanthan in a water-ethanol (P1) was carried out, but replacing the xanthan with a chemically-modified xanthan gum esterified with dodecanoic acid. 26 g of polysaccharide (P3) were isolated in the form of a white powder with a yield equal to 86.7% (relative to the C-12 lipophilized xanthan introduced).

Preparation of STMP-crosslinked xanthan in a water-isopropanol mixture (according to the invention).

The same process as the one described in the paragraph describing the preparation of STMP-crosslinked xanthan in a water-ethanol (P1) was carried out, but replacing the ethanol with isopropanol. 24.5 g of polysaccharide (P4) were isolated in the form of a white powder with a yield equal to 81.7% (relative to the xanthan introduced).

Preparation of STMP-crosslinked konjac gum in a water-ethanol mixture (according to the invention). The same process as the one described in the paragraph describing the preparation of STMP-crosslinked xanthan gum in a water-ethanol mixture (P2) was carried out, but replacing the xanthan with konjac gum. The polysaccharide (P5) was isolated in the form of a white powder.

Preparation of STMP-crosslinked guar gum in a water-ethanol mixture (according to the invention). The same process as the one described the paragraph describing the preparation of STMP-crosslinked xanthan gum in a water-ethanol mixture (P2) was carried out, but replacing the xanthan with guar gum. 54.3 g of polysaccharide (P6) was isolated in the form of a white powder with a yield equal to 90.5% (relative to the guar gum introduced).

Preparation of STMP-crosslinked kappa-carrageenan (κ-carrageenan) in a water-ethanol mixture (according to the invention). The same process as the one described the paragraph describing the preparation of STMP-crosslinked xanthan gum in a water-ethanol mixture (P2) was carried out, but replacing the xanthan with κ-carrageenan and heating the medium obtained in step A) at 80° C. for one hour. 52.5 g of polysaccharide (P7) were isolated in the form of a white powder with a yield equal to 87.5% (relative to the κ-carrageenan introduced).

Preparation of STMP-crosslinked iota-carrageenan (ι-carrageenan) in a water-ethanol mixture (according to the invention). The same process as the one described in the paragraph describing the preparation of STMP-crosslinked kappa-carrageenan (κ-carrageenan) in a water-ethanol mixture (P7) was carried out, but replacing the κ-carrageenan with ι-carrageenan. 52.8 g of polysaccharide (P8) were isolated in the form of a white powder with a yield equal to 88% (relative to the ι-carrageenan introduced).

Preparation of STMP-crosslinked ι-carrageenan in a water-ethanol mixture and in the presence of calcium sulfate (according to the invention). The same process as the one described in the paragraph describing the preparation of STMP-crosslinked iota-carrageenan (ι-carrageenan) in a water-ethanol mixture (P8) was carried out, but introducing 0.3 g of calcium sulfate in step A). The polysaccharide (P9) was isolated in the form of a white powder.

Preparation of STMP-crosslinked κ-carrageenan in a water-ethanol mixture and in the presence of calcium sulfate (according to the invention). The same process as the one described in the paragraph describing the preparation of STMP-crosslinked ι-carrageenan in a water-ethanol mixture (P9) and in the presence of calcium sulfate was carried out, but replacing the ι-carrageenan with κ-carrageenan. 53.3 g of polysaccharide (P10) were isolated in the form of a white powder with a yield equal to 88.8% (relative to the κ-carrageenan introduced).

Preparation of an STMP-crosslinked xanthan-ι-carrageenan mixture in a water-ethanol mixture (according to the invention). The same process as the one described in the paragraph describing the preparation of STMP-crosslinked ι-carrageenan in a water-ethanol mixture (P8) was carried out, but adding 54 g of xanthan in step A) (xanthan/ι-carrageenan weight ratio=9.0). 54.7 g of polysaccharide (P11) were isolated in the form of a white powder with a yield equal to 91.2% (relative to the xanthan-ι-carrageenan mixture introduced).

Preparation of an STMP-crosslinked xanthan-ι-carrageenan mixture in a water-ethanol mixture (according to the invention). The same process as the one described in the paragraph describing the preparation of an STMP-crosslinked xanthan-ι-carrageenan mixture in a water-ethanol mixture (P11) was carried out, but inverting the xanthan/ι-carrageenan weight ratio. For this, 6 g of xanthan and 54 g of ι-carrageenan were used (xanthan/ι-carrageenan weight ratio=0.1). 54.4 g of polysaccharide (P12) were isolated in the form of a white powder with a yield equal to 90.7% (relative to the xanthan-ι-carrageenan mixture introduced).

Preparation of an STMP-crosslinked xanthan-κ-carrageenan mixture in a water-ethanol mixture (according to the invention). The same process as the one described in the paragraph describing the preparation of an STMP-crosslinked xanthan-ι-carrageenan mixture in a water-ethanol mixture (P11) was carried out, but replacing the ι-carrageenan with κ-carrageenan (xanthan/κ-carrageenan weight ratio=9.0). 53.5 g of polysaccharide (P13) were isolated in the form of a white powder with a yield equal to 89.2% (relative to the xanthan/κ-carrageenan mixture introduced).

Preparation of an STMP-crosslinked xanthan-κ-carrageenan mixture in a water-ethanol mixture (according to the invention). The same process as the one described in the paragraph describing the preparation of an STMP-crosslinked xanthan-ι-carrageenan mixture in a water-ethanol mixture (P12) was carried out, but inverting the xanthan/κ-carrageenan weight ratio. For this, 6 g of xanthan and 54 g of κ-carrageenan were used (xanthan/κ-carrageenan weight ratio=0.1). 54.3 g of polysaccharide (P14) were isolated in the form of a white powder with a yield equal to 90.5% (relative to the xanthan/κ-carrageenan mixture introduced).

Preparation of aqueous gels—Evaluation of thickening properties of the polymers prepared. The thickening properties of the STMP-crosslinked polysaccharides according to the invention, polysaccharide (P1) to polysaccharide (P14), were evaluated and compared with those of the corresponding non-crosslinked polysaccharides. The same characterization was carried out on the polysaccharide (P1′), the crosslinking step of which was carried out at a low pH outside of the invention.
Preparation of aqueous gels: The method for producing aqueous gels consists in introducing, into a 2-litre beaker, the amount of water needed for the preparation of an 800 g gel, i.e. 792 g of water in the case of a gel containing 1% by weight of crosslinked product. A mechanical stirrer impeller, connected to a motor, is placed at the bottom of the beaker. Stirring is started and the necessary amount of crosslinked polysaccharide is introduced into the beaker with stirring. The stirring creates a vortex which disappears when the polysaccharide becomes hydrated and forms a gel. In the particular case of polysaccharides which develop their viscosity under a thermal effect, it may be necessary to heat the gel to between 50° C. and 100° C. in order to aid solubilization. A portion of the gel formed is kept for the viscosity measurement. The other portion is used to produce a gel containing 1% of polysaccharide+0.5% of sodium chloride. For this, 398 g of gel are stirred using a mechanical stirrer impeller connected to a motor, and 2 g of sodium chloride are then added. Stirring is maintained until the sodium chloride is completely solubilized and a homogeneous gel is obtained. The gels thus prepared are evaluated three hours and then twenty-four hours after preparation. The viscosity of the gel is measured using a Brookfield RVT viscometer (speed 5, spindle suitable for the viscosity) or a Brookfield LVT viscometer (speed 6). The experimental results are collated in Tables 1 and 3 below.

TABLE 1

| | Gel containing 1% PS | | Gel containing 2% PS | |
|---|---|---|---|---|
| | Viscosity in mPa · s | | Viscosity in mPa · s | |
| | Increase in viscosity in % *** | | Increase in viscosity in % *** | |
| Polysaccharide (PS)↓ | | | | |
| Non-crosslinked PS↓ | Without NaCl | 0.5% NaCl | Without NaCl | 0.5% NaCl |
| Xanthan | 3140 | 12 650 | 11 600 | 40 200 |
| C-12 xanthan | 32 000 | 5000 | Nd | Nd |
| Konjac gum | 26 200 | 24 800 | Nd | Nd |
| Guar gum | 12 000 | 11 800 | Nd | Nd |
| κ-Carrageenan | 10 080 | 39 400 | Nd | Nd/ |
| ι-Carrageenan | Nd | Nd | 45 600 | 45 200 |
| λ-Carrageenan + CaSO₄ | 13 400 | 10 000 | Nd | Nd |
| κ-Carrageenan + CaSO₄ | 60 600 | 33 200 | Nd | Nd |
| Xanthan - ι-Carrageenan | Nd | Nd | 5600 | 40 600 |
| (9.0) | | | | |
| Xanthan - ι-Carrageenan | Nd | Nd | 11 400 | 113 600 |
| (0.1) | | | | |

TABLE 2

| | Gel containing 1% PS | | Gel containing 2% PS | |
|---|---|---|---|---|
| | Viscosity in mPa · s | | Viscosity in mPa · s | |
| | Increase in viscosity in % *** | | Increase in viscosity in % *** | |
| Non-crosslinked PS↓ | Without NaCl | 0.5% NaCl | Without NaCl | 0.5% NaCl |
| Xanthan - κ-Carrageenan (9.0) | Nd | Nd | 8400 | 50 000 |
| Xanthan - ι-Carrageenan (0.1) | Nd | Nd | 11 400 | 113 600 |
| Xanthan/κ-carrageenan (9.0) | Nd | Nd | 8400 | 50 000 |
| Crosslinked PS↓ | Without NaCl | 0.5% NaCl | Without NaCl | 0.5% NaCl |
| Polysaccharide (P1) | 32 500 | 13 740 | Nd | Nd |
| | (+935.0%) | (+8.6%) | | |
| Polysaccharide (P1′) | 4400 | 16 100 | Nd | Nd |
| | (+40.1%) | (+27.3%) | | |
| Polysaccharide (P2) | 12 000 | 18 600 | 29 800 | 51 800 |
| | (+282.2%) | (+47.0%) | (+156.9%) | (+28.9%) |
| Polysaccharide (P3) | 19 000 | 4110 | Nd | Nd |
| | (+505.1%) | (−67.5%) | | |
| Polysaccharide (P4) | 23 000 | 16 100 | Nd | Nd |
| | (+632.5%) | (+27.3%) | | |
| Polysaccharide (P5) | 59 600 | 40 000 | Nd | Nd |
| | (+127.5%) | (+61.3%) | | |
| Polysaccharide (P6) | 12 400 | 12 200 | Nd | Nd |
| | (+3.3%) | (+3.4%) | | |

TABLE 3

| | Gel containing 1% PS | | Gel containing 2% PS | |
|---|---|---|---|---|
| | Viscosity in mPa · s | | Viscosity in mPa · s | |
| | Increase in viscosity in % *** | | Increase in viscosity in % *** | |
| Crosslinked (PS)↓ | Without NaCl | 0.5% NaCl | Without NaCl | 0.5% NaCl |
| Polysaccharide (P7) | 19 800 | 59 800 | Nd | Nd |
| Polysaccharide (P8) | Nd | Nd | 83 200 | 62 800 |
| | | | (+82.5%) | (+38.9%) |
| Polysaccharide (P9) | 24 200 | 16 200 | Nd | Nd |
| | (+80.6%) | (+62.0%) | | |
| Polysaccharide (P10) | 67 600 | 103 400 | Nd | Nd |
| | (+11.6%) | (+211.4%) | | |
| Polysaccharide (P11) | Nd | Nd | 16 400 | 46 200 |
| | | | (+192.9%) | (+13.8%) |
| Polysaccharide (P12) | Nd | Nd | 22 200 | 118 600 |
| | | | (+94.7) | (+4.4%) |
| Polysaccharide (P13) | Nd | Nd | 26 000 | 41 600 |
| | | | (+209.5%) | (−16.8%) |
| Polysaccharide (P14) | Nd | Nd | 61 800 | 56 600 |
| | | | (+11.9%) | (−62.1%) |

Nd: not determined
*** increase in viscosity = [(viscosity (PX) - viscosity of the corresponding non-crosslinked polysaccharide)/viscosity of the corresponding crosslinked polysaccharide] × 100.

### CONCLUSIONS

The correct implementation of the crosslinking reactions followed by the precipitation of the crosslinked polysaccharide isolated in powder form (~100% polymer) was demonstrated.
In most cases, the crosslinking of the polysaccharides with STMP makes it possible to increase the viscosity of the gels containing 100 or 2% of polysaccharides crosslinked in the presence or absence of NaCl. These relative increases with respect to the same, non-crosslinked polysaccharides vary between 3.3% (cf. (P6)) and 935% (cf. (P1)). In a limited number of cases, a decrease is observed (cf. (P3), (P13) and (P14)).
The use of ethanol or isopropanol as a crosslinking cosolvent makes it possible to achieve comparable increases in terms of gel viscosity (cf. (P1) and (P4)).
Examples (P1) and (P1′) make it possible to assess the influence of the pH (12.5 and 7.0 respectively) during the crosslinking step.
The crosslinking process according to the invention was validated using single polysaccharides and mixtures of polysaccharides.

### Examples of Detergent Formulations According to the Invention

TABLE 4
Cleaning gel for ovens and cooking racks

| Ingredients | Weight proportions (%) |
|---|---|
| SIMULSOL ™ OX1309L | 2% |
| SIMULSOL ™ SL7G | 2% |
| Crosslinked polysaccharide (P1) | 6% |
| Sodium hydroxide: | 25% |
| Water: | qs 100% |

Visual appearance of the gel

| | |
|---|---|
| At t = 0 at 25° C. | Homogeneous |
| After 6 months at 25° C. | |

Viscosity of the gel (Brookfield LVT 6 rpm)

| | |
|---|---|
| At t = 0 at 25° C. | 10 000 mPa · s |
| After 6 months at 25° C. | 12 000 mPa · s |

TABLE 5
Cleaner for aluminium surfaces

| Ingredients | Weight proportions |
|---|---|
| SIMULSOL ™ OX1309L | 3% |
| SIMULSOL ™ SL7G | 3% |
| Crosslinked polysaccharide (P1) | 5% |
| 75% phosphoric acid | 40% |
| HORDAPHOS MDGB 1% | 5% |
| Dipropylene glycol methyl ether | 5% |
| Water: | qs 100% |
| Visual appearance after storing for one month at 40° C. | Clear and homogeneous |

TABLE 6
Ingredients used in the detergent formulations mentioned above

| Trade name | Composition |
|---|---|
| SIMULSOL ™ OX1309L | Detergent surfactant composition comprising polyethoxylated |
| | alcohols resulting from the reaction of one molar equivalent of |
| | the alcohol EXXAL ™ 13 with 9 molar equivalents of ethylene |
| | oxide |
| SIMULSOL ™ SL7G | solution of n-heptyl polyglucosides, hydrotropic agent and |
| | solubilizer. |
| HORDAPHOS MDGB 1% | Composition based on phosphoric esters, used as an |
| | anticorrosion agent. |

1. A process for preparing a crosslinked polysaccharide, the process comprising:
a) preparing a water-polar solvent mixture, the polar solvent is selected from the group consisting of aliphatic alcohols containing from one to four carbon atoms, ketones containing from three to five carbon atoms, polyols containing two or three hydroxyl groups and from two to six carbon atoms, and combinations thereof, wherein the preparation is carried out by mixing water and the polar solvent in weight proportions such that a weight ratio of the polar solvent to the water is greater than or equal to 0.4 and less than or equal to 19.0;
b) dispersing at least one polysaccharide in the water-polar solvent mixture prepared in step a) to obtain a reaction medium comprising, per 100% of its weight, a weight proportion of the polysaccharide of greater than 10% by weight and less than or equal to 55% by weight, the polysaccharide is selected from the group consisting of xanthan gum, xanthan grafted with hydrocarbon chains containing from two to twenty-two carbon atoms, and combinations thereof;
c) adjusting a pH of the reaction medium prepared in step b) to a value greater than or equal to 8.0 and less than or equal to 13.0 by adding a base thereto;
d) crosslinking the at least one polysaccharide by adding, to the basic reaction medium obtained at the end of step c), a phosphate crosslinking agent selected from the group consisting of sodium trimetaphosphate (STMP), sodium tripolyphosphate (STPP), and combinations thereof to obtain a basic dispersion comprising at least one crosslinked polysaccharide;
e) adjusting a pH of the basic dispersion obtained at the end of step d), to a value less than or equal to 7.0 to obtain a non-basic dispersion of the at least one crosslinked polysaccharide and
f) filtering the non-basic dispersion obtained at the end of step e) to recover therefrom the at least one crosslinked polysaccharide, optionally followed by:
either g) drying the at least one crosslinked polysaccharide to remove traces of residual solvents therefrom,
or h) atomizing the at least one crosslinked polysaccharide obtained in step f) to obtain a powder therefrom.

2. The process according to claim 1, wherein steps a) and b) are simultaneous and constitute a single step A) of preparing the reaction medium by mixing water, the polar solvent selected from the group consisting of aliphatic alcohols containing from one to four carbon atoms, ketones containing from three to five carbon atoms, polyols containing two or three hydroxyl groups and from two to six carbon atoms, and combinations thereof, and the polysaccharide in proportions such that:
the weight proportion of the at least one polysaccharide is greater than 10% by weight and less than or equal to 55% by weight of the reaction medium and that
the weight ratio of the polar solvent to the water in the mixture is greater than or equal to 0.4 and less than or equal to 19.0.

3. The process according to claim 1, wherein the polar solvent of the mixture prepared in step a) or of the reaction medium prepared in step A) is selected from the group consisting of methanol, ethanol, butanol, isopropanol, acetone, methyl ethyl ketone, glycerol, 1,3-propanediol, butylene glycol, 1,3-butanediol, pentylene glycol, hexylene glycol, 2-methyl-2,4-pentanediol, and combinations thereof.

4. The process according to claim 1, wherein the weight ratio of the polar solvent to the water in the mixture prepared in step a) or in the reaction medium prepared in step A) is greater than or equal to 1.0 and less than or equal to 4.0.

5. The process according to claim 1, wherein the reaction medium prepared in step b) or in step A) comprises, per 100% of its weight, a weight proportion of the at least one polysaccharide of greater than or equal to 15% and less than or equal to 45% by weight.

6. The process according to claim 1, wherein, in step c), the pH is adjusted to a value greater than or equal to 10.0 and less than or equal to 12.5.

7. The process according to claim 1, wherein the weight ratio of the crosslinking agent used in step d) to the at least one polysaccharide is greater than or equal to 0.0001 and less than or equal to 0.0700.

8. The process according to claim 1, wherein the crosslinking agent used in step d) is sodium trimetaphosphate (STMP).

9. A method for thickening, stabilizing or emulsifying a detergent formulation for industrial or domestic use, comprising a polar phase or for suspending solid particles therein, the method comprising providing the crosslinked polysaccharide or the mixture of crosslinked polysaccharides obtained by the process according to claim 1 to the detergent formulation.

10. A detergent formulation for industrial or domestic use, comprising a polar phase, wherein the detergent formulation comprises, per 100% of its weight, from 0.10% to 10.0% of the crosslinked polysaccharide or the mixture of crosslinked polysaccharides obtained by the process according to claim 1, as thickener, as stabilizer or as emulsifier for the detergent formulation for industrial or domestic use, comprising the polar phase, or as an agent capable of and intended for suspending solid particles within the detergent formulation for industrial or domestic use, comprising the polar phase.

11. A process for cleaning a surface, the process comprising cleaning the surface with the detergent formulation as defined in claim 10.

12. A process for cleaning a surface, the process comprising at least one first step a1) of applying the detergent formulation as defined in claim 10, followed by at least one step b1) of rinsing the surface.

13. The process of claim 1, wherein the polysaccharide is esterified with dodecanoic acid, guar gum, konjac gum, carrageenans, or combinations thereof.

14. The process of claim 13, wherein the polysaccharide is esterified with kappa-carrageenan, iota-carrageenan, or mixtures thereof.

15. The process according to claim 3, wherein the polar solvent of the mixture prepared in step a) or of the reaction medium prepared in step A) is selected from the group consisting of ethanol, isopropanol, and combinations thereof.

16. The process according to claim 7, wherein a weight ratio of the crosslinking agent used in step d) to the at least one polysaccharide is greater than or equal to 0.0003 and less than or equal to 0.0300.

17. The detergent formulation according to claim 10, wherein the detergent formulation comprises, per 100% of its weight, from 0.5% to 5.0% of the crosslinked polysaccharide or the mixture of crosslinked polysaccharides.
